(19) United States
(12) Patent Application Publication
(10) Pub. No.: US 2025/0083194 A1
(43) Pub. Date: Mar. 13, 2025

(54) TOOLS FOR CLEANING A GRILL GRATE

(71) Applicant: Paul Bertorelli, Nahant, MA (US)

(72) Inventor: Paul Bertorelli, Nahant, MA (US)

(21) Appl. No.: 18/958,593

(22) Filed: Nov. 25, 2024

Related U.S. Application Data
(63) Continuation-in-part of application No. 18/296,590, filed on Apr. 6, 2023.
(60) Provisional application No. 63/626,701, filed on Jan. 30, 2024.
(60) Provisional application No. 63/365,394, filed on May 26, 2022.

(51) Int. Cl. B08B 1/12; A46B 7/04; A46B 9/10; A47J 37/07; A47L 13/022; B08B 1/30

(52) U.S. Cl. CPC B08B 1/12; A46B 7/044; A46B 9/10; A47J 37/0786; A47L 13/022; B08B 1/30

(57) ABSTRACT

Various grill cleaning tools improve the effectiveness of use compared to existing designs. The cleaning tools have a handle. A first tool includes a housing with a sleeve and/or a ring formed at an end of the handle, and a parallel array of scraping pins mounted within a pin plate housed within and extending from the housing. A second tool includes a head formed at an end of the handle; a shaft mounted on the head and secured with fastening hardware; and washers mounted on the shaft. A first set of the washers are displaced when pressed against a surface as compared to a second set of the washers that remain in a resting position. A third tool includes a planar base; a metal support mounted to the base; and an abrasive component fastened to the support. Corresponding methods of use are also described.

### CROSS-REFERENCE TO RELATED APPLICATION

This application is a continuation-in-part of U.S. application Ser. No. 18/296,590, filed Apr. 6, 2023. U.S. application Ser. No. 18/296,590 claimed the benefit of priority of U.S. provisional application No. 63/365,394, filed May 26, 2022. This application also claims the benefit of priority of U.S. provisional application No. 63/626,701, filed Jan. 30, 2024. The contents of U.S. application Ser. Nos. 18/296,590, 63/365,394, and 63/626,701 are incorporated herein by reference in their entireties.

### BACKGROUND OF THE INVENTION

The present invention relates to grill brushes and, more particularly, to tools for cleaning a grill grate.

Currently available bristle brush devices for cleaning an outdoor grill grate can break down over time and tend to leave debris on the grill grate, such as metal bristles. The debris on the cooking surface may stick to food and be ingested. The use of cleaning devices that are not formed from metal can be limited by temperature (i.e., can't be used at high temperatures), meaning they can't be used when the grill is too hot. Further, current metal bristle designs are not effective at thoroughly cleaning grill grates.

As can be seen, there is a need for a better performing, more durable grill cleaning device that is bristle free.

### SUMMARY OF THE INVENTION

In one aspect of the present invention, a cleaning tool comprises an elongated handle; a housing formed at an end of the elongated handle, wherein the housing comprises a sleeve and/or a ring; a pin plate housed within the housing; and a plurality of scraping pins configured as a parallel array mounted within the pin plate, and extending from the housing.

In another aspect of the present invention, a cleaning tool comprises a handle; a cleaning tool head formed at an end of the handle; a shaft mounted on the cleaning tool head and secured thereto with fastening hardware; and a plurality of washers mounted on the shaft; wherein a first set of the plurality of washers are displaced when pressed against a surface as compared to a second set of the plurality of washers that remain in a resting position.

In yet another aspect of the present invention, a grill cleaner comprises a planar base; a handle mounted to the planar base; a metal support mounted to the planar base; and an abrasive component fastened to the metal support; wherein the handle, the metal support, and the abrasive component are fastened to the planar base.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of a device according to a first embodiment of the present invention, shown in use;

FIG. 2 is a bottom perspective view thereof;

FIG. 3 is a detail view thereof, taken along line 3-3 in FIG. 2;

FIG. 4 is an exploded view of the device of FIG. 1;

FIG. 5 is a detail view thereof;

FIG. 6 is a side elevation view of the device of FIG. 1;

FIG. 7 is another side elevation view thereof, shown in a first position;

FIG. 8 is another side elevation view thereof, shown in a second position;

FIG. 9 is a perspective view of a device according to a second embodiment of the present invention;

FIG. 10 is a bottom perspective view thereof;

FIG. 11 is an exploded view thereof;

FIG. 12 is a side elevation view thereof, shown in a first position;

FIG. 13 is another side elevation view thereof, shown in a second position;

FIG. 14 is a front elevation view thereof, shown in use;

FIG. 15 is a perspective view of a device according to a third embodiment of the present invention;

FIG. 16 is a bottom perspective view thereof;

FIG. 17 is an exploded view thereof; and

FIG. 18 is a detail sectional view thereof, taken along line 18-18 in

FIG. 16;

FIG. 19 is a perspective view of a device according to a fourth embodiment of the present invention;

FIG. 20 is another perspective view thereof, shown in use;

FIG. 21 is an exploded view thereof;

FIG. 22 is a perspective view of a device according to a fifth embodiment of the present invention;

FIG. 23 is an exploded view thereof;

FIG. 24 is a perspective view of a device according to a sixth embodiment of the present invention;

FIG. 25 is an exploded view thereof;

FIG. 26 is a schematic view of a device according to a seventh embodiment of the present invention, illustrating disassembly for cleaning;

FIG. 27 is a perspective view of a device according to an eighth embodiment of the present invention;

FIG. 28 is an exploded view thereof;

FIG. 29 is another exploded view thereof, shown with washers according to a ninth embodiment of the present invention;

FIG. 30 is another exploded view thereof, shown with washers according to a tenth embodiment of the present invention;

FIG. 31 is a perspective view of a device according to an eleventh embodiment of the present invention;

FIG. 32 is an exploded view thereof;

FIG. 33 is a perspective view of a device according to a twelfth embodiment of the present invention; and

FIG. 34 is an exploded view thereof.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured.

Broadly, an embodiment of the present invention provides a bristle free device that cleans an outdoor grill grate better than a bristle brush. The lack of bristles makes the cleaning tool safer to use. Embodiments of the present invention will not leave metal bristles on the cooking surface and can be used at any temperature.

The cleaning apparatus disclosed herein provides superior effectiveness for cleaning a barbecue grill surface as well known in the art. The cleaning elements automatically self-articulate around three surfaces of the grill rails when dragged across the surface. The cleaning mechanism may be fixed or removable and may comprise individually separable components or may be configured as a cartridge.

In some embodiments, a tool handle component may couple to a tool head component by way of fastening hardware and/or they may snap or clip together.

In some embodiments, the tool may have scraping elements, such as pins, washers, mesh sheaths, or wire rope that are permanently fixed to the tool body. In other embodiments, the scraping elements may be removed for easier cleaning. In an exemplary embodiment, the cleaning tools may comprise pins that are about 1.5 inches long with one end smaller than the other end.

In some embodiments, the cleaning tool may have an adjustable pin height actuated with a thumb screw.

In some embodiments, the cleaning tool may have a weight disk operative to urge pins to protrude from the tool head.

The scraping elements accommodate the grate surface, thereby mirroring the grill grate surface and cleaning 3 sides of the grate surface simultaneously.

In some embodiments, the bristle free cleaning tool disclosed herein may further include a scraper blade.

The cleaning elements of the grill cleaning tool disclosed herein are configured to adapt to the shape of a grill grate for which it is used. The grill cleaning tool is configured for use with all grill grates currently available. In other words, the elements of the tool shift to accommodate the elements of the grate.

In some embodiments, the cleaning tool may have a plurality of washers or teeth on a shaft, which may be, for example, a wire, a pin, or a bolt. For example, a wire may extend through holes in washers and may be fastened to the body or handle of the tool, with both ends of the wire secured to the tool. In some aspects, the shaft may be affixed to a wishbone shaped handle. The washers may be any suitable shape, such as round, square, or octagonal, for example. In some embodiments, the washers may be substantially square or rectangular with concave edges. In some aspects, the corners of the square or rectangular washers may be truncated, forming a planar surface transitioning between adjacent edges. For example, the washers may be 3 cm square. The washers may be of a selected thickness or may have a variety of thicknesses. Any suitable number of washers may be installed, such as about 25-75 washers, preferably about 40-60 washers, e.g., about 50 washers.

In some embodiments, the tool may be a cleaning apparatus having a floating, articulating, self-leveling cleaning mechanism comprising geometrically shaped cleaning elements, i.e., elements having a round or polygonal shape, anchored by a common solid axle or axis which is suspended between two end-supports. The elements may be tightly stacked, i.e., the elements abut one another when assembled. The cleaning elements have an aperture with a diameter greater than the diameter of the axle, such that the elements are generally free to rotate and shift position across the axle. The cleaning elements may be thin fins, blades, or wedges, for example, i.e., the elements have a thickness substantially less than the height and depth thereof. The end-supports may be posts or bars, similar to the configuration of a slingshot.

The bristle free grill cleaning tool disclosed herein is manufactured of durable, dishwasher safe materials so it will last a long time and is easy to clean. The elements may be manufactured of a metal or other comparably hard and heat-resistant material. The tools according to embodiments of the present invention have handles manufactured of any suitable material. The material may be metal, such as stainless steel, heat-resistant plastic, silicone, or wood, for example.

While intended primarily for grill use, those with skill will appreciate that the present invention can be used to clean various surfaces. The tools disclosed herein may be used to clean any surface that needs cleaning.

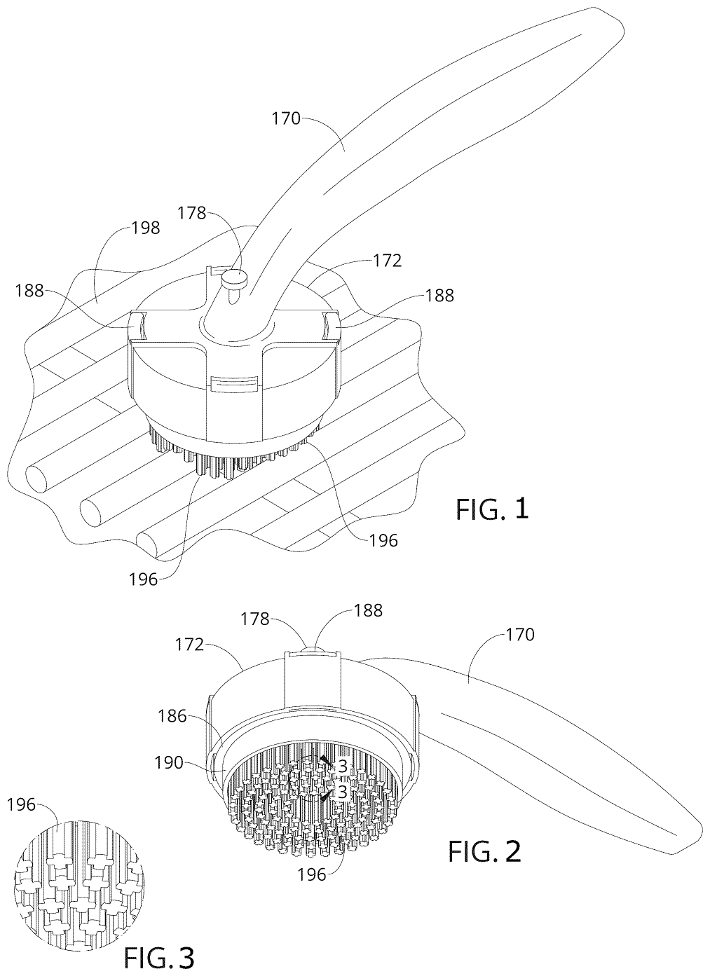

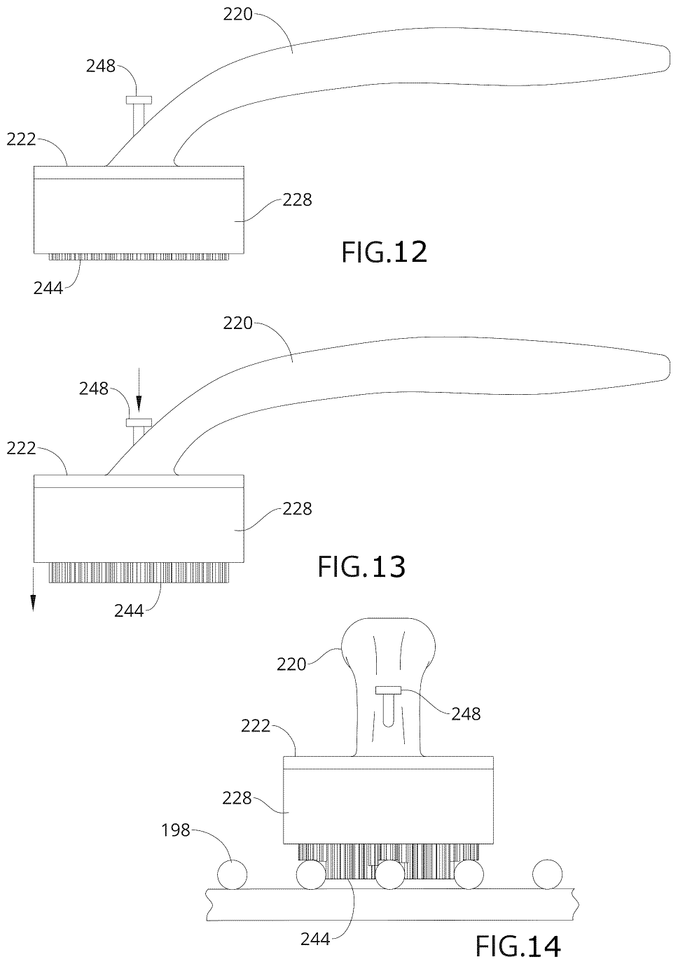

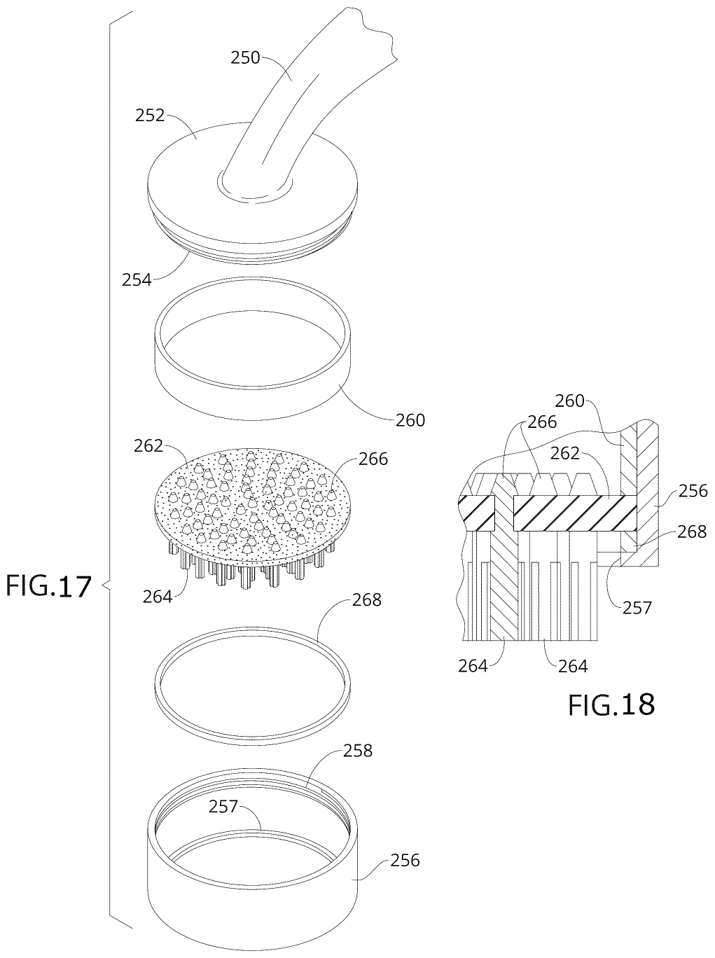

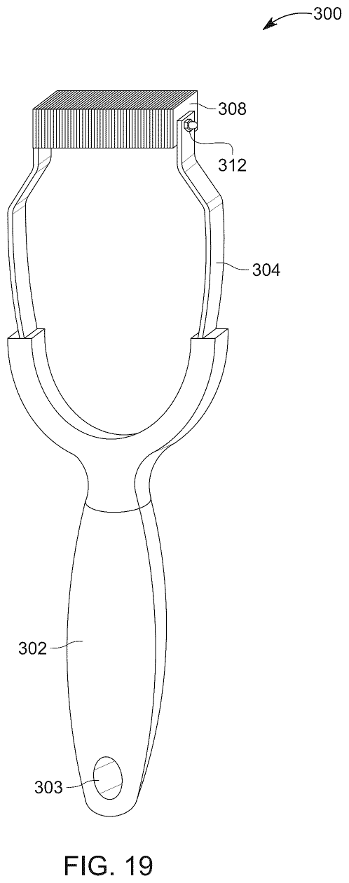

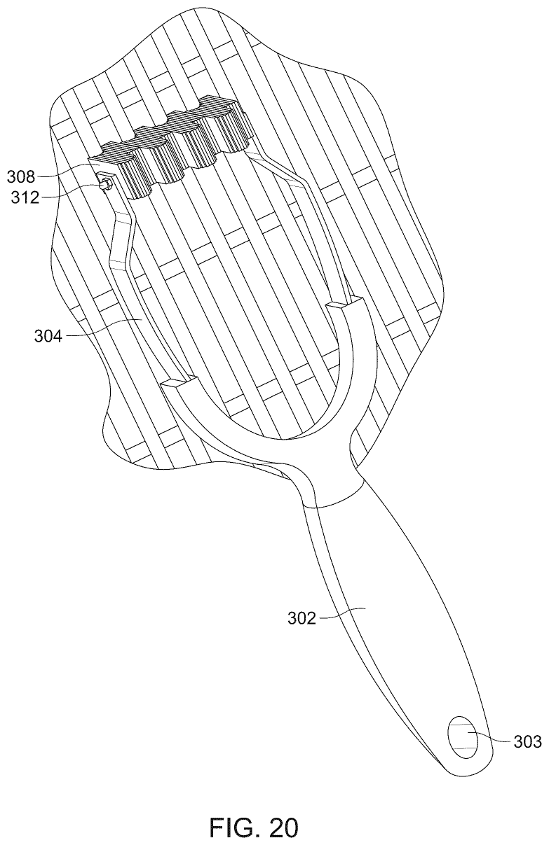

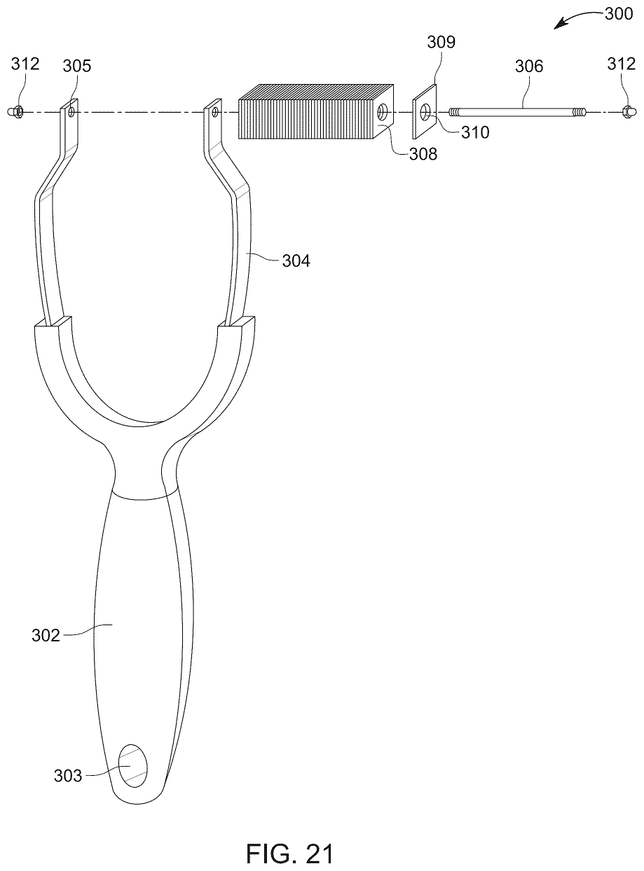

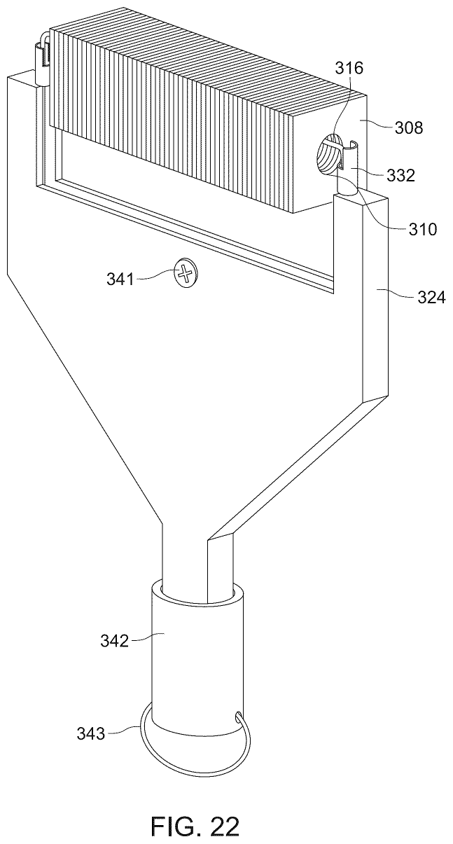

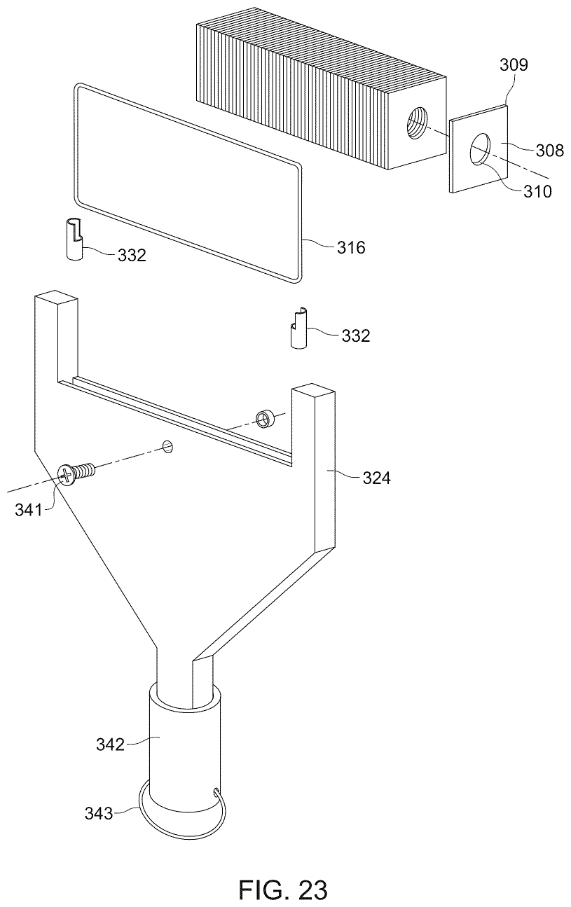

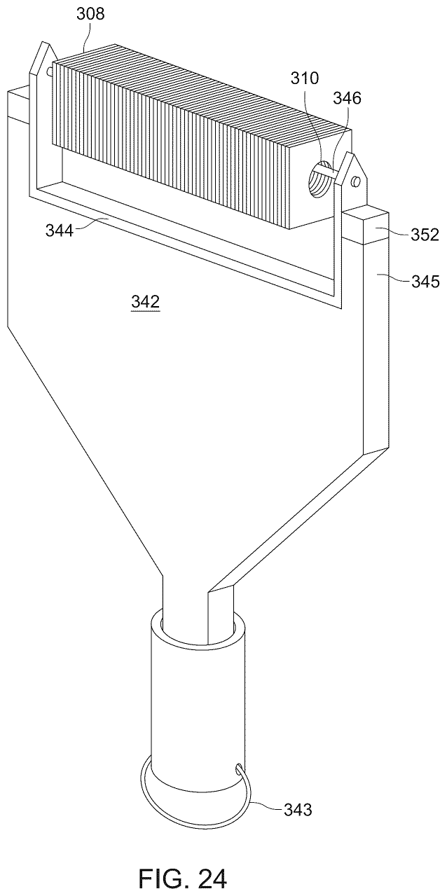

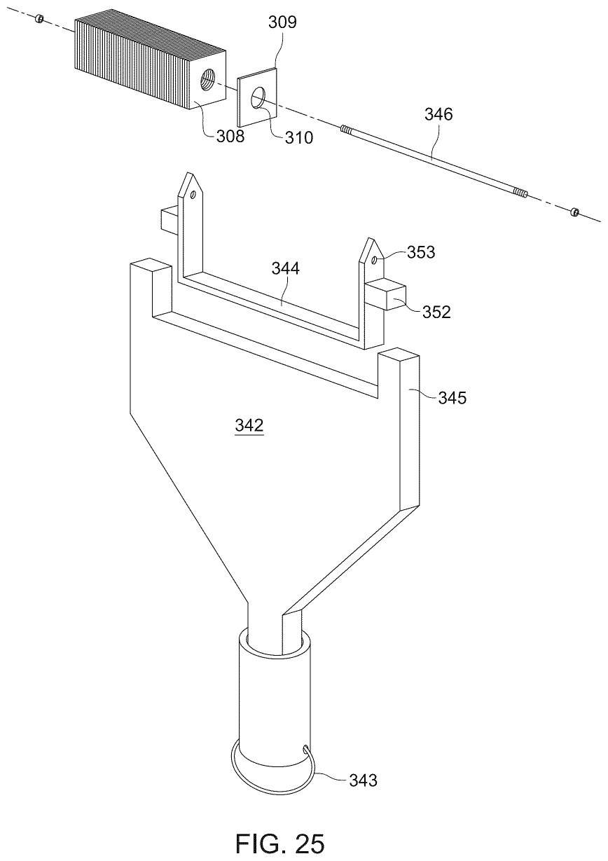

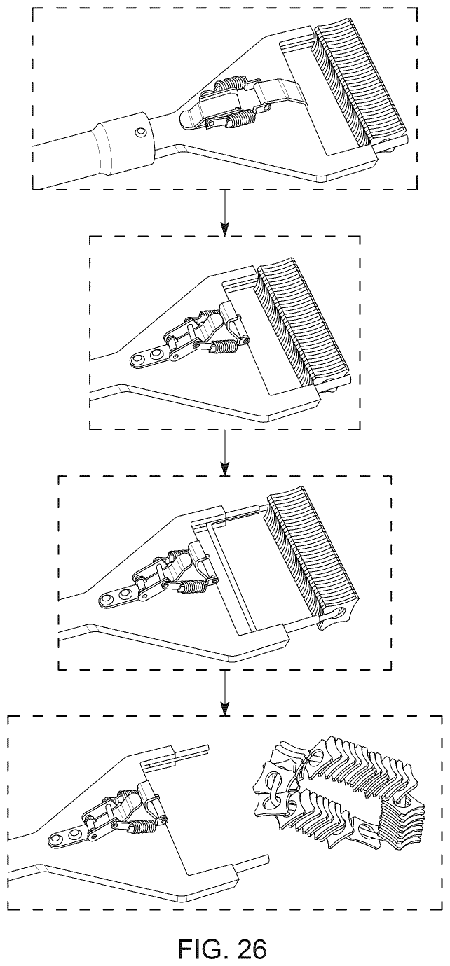

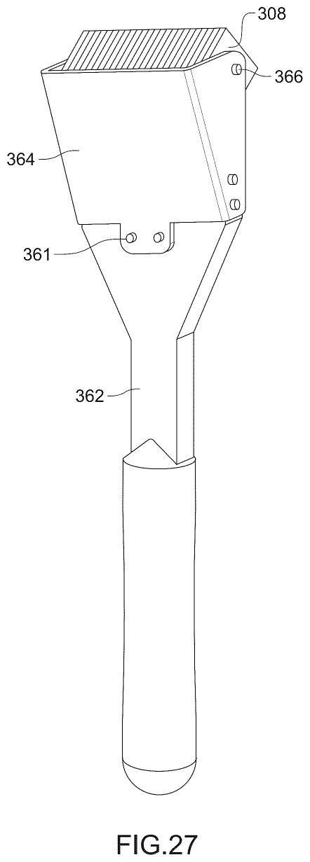

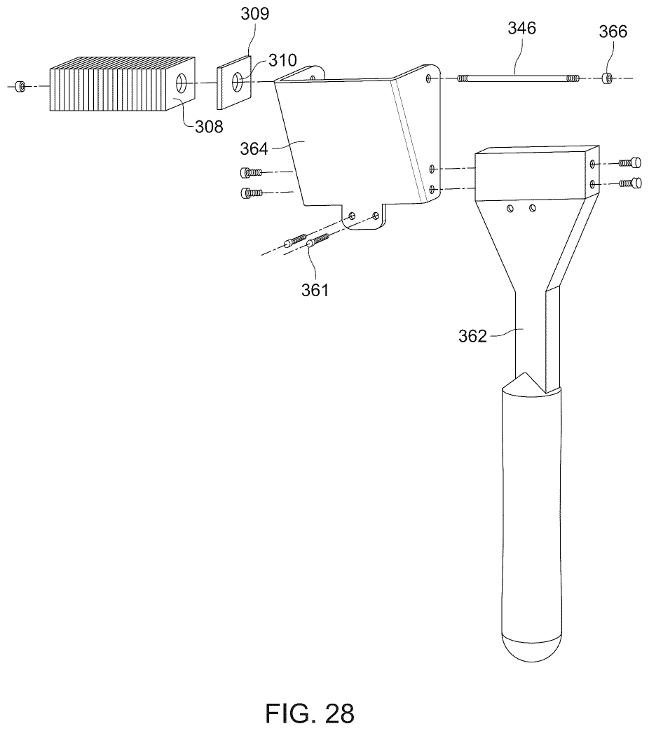

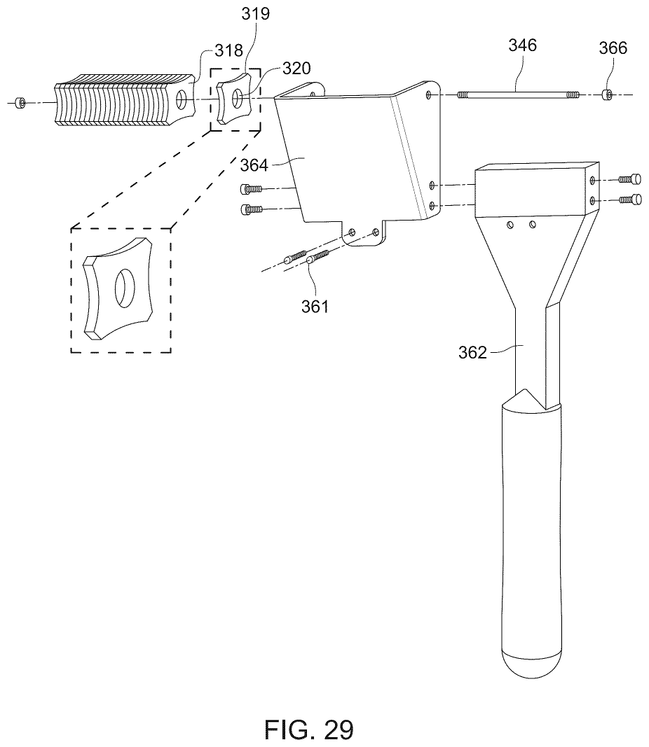

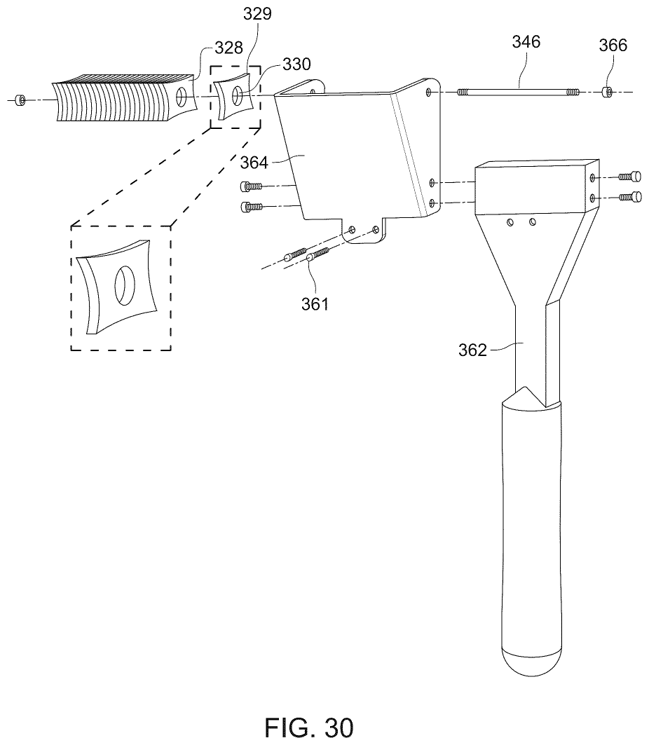

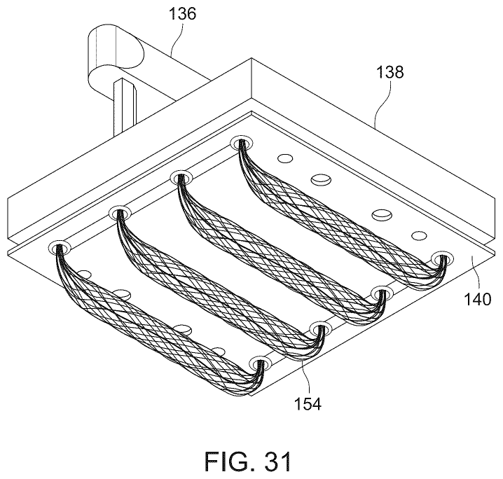

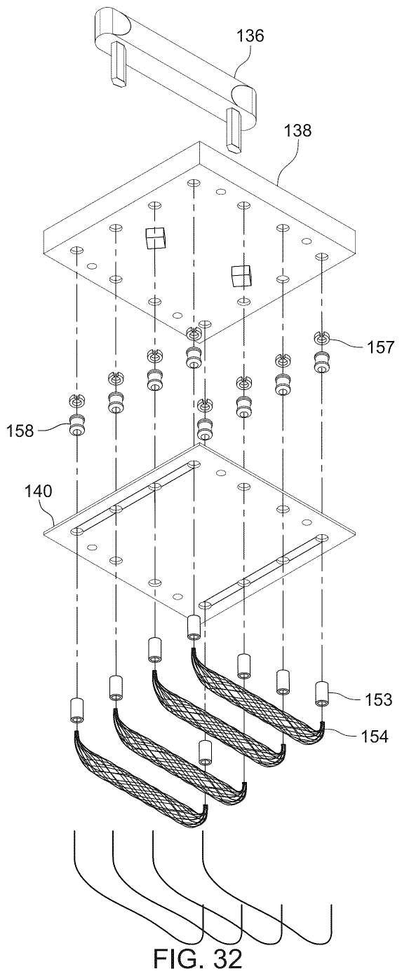

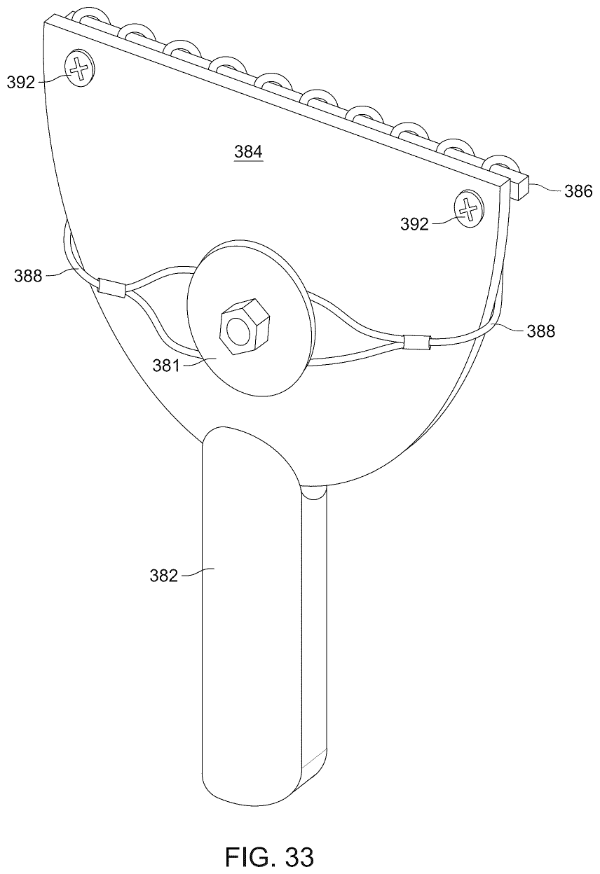

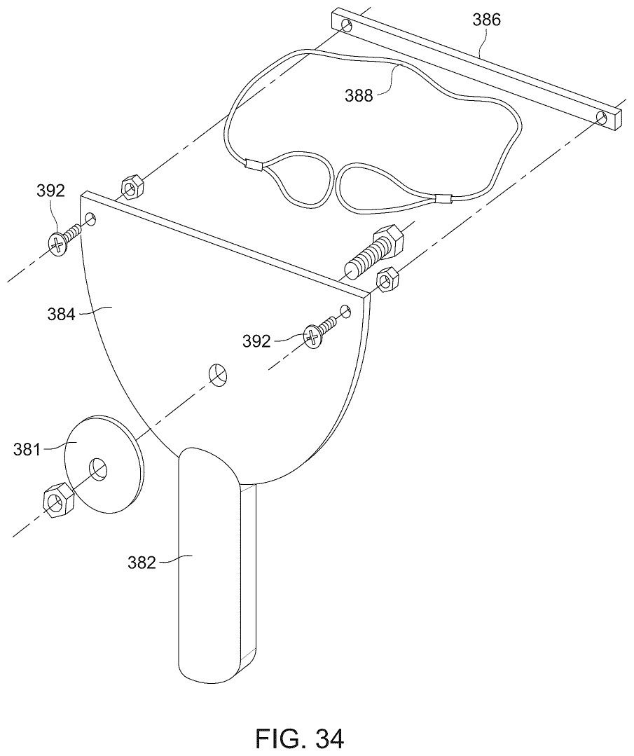

Referring now to FIGS. 1-34, embodiments of the cleaning tool are described. It will be appreciated by those with skill in the art that all the illustrated embodiments are configured in a way that allows them to conform to the shape of a grill. They are very safe, as they do not include bristles in the design. The elements may be adjusted to cover gaps in a grid, so that the elements may clean the top and sides of grill grate components.

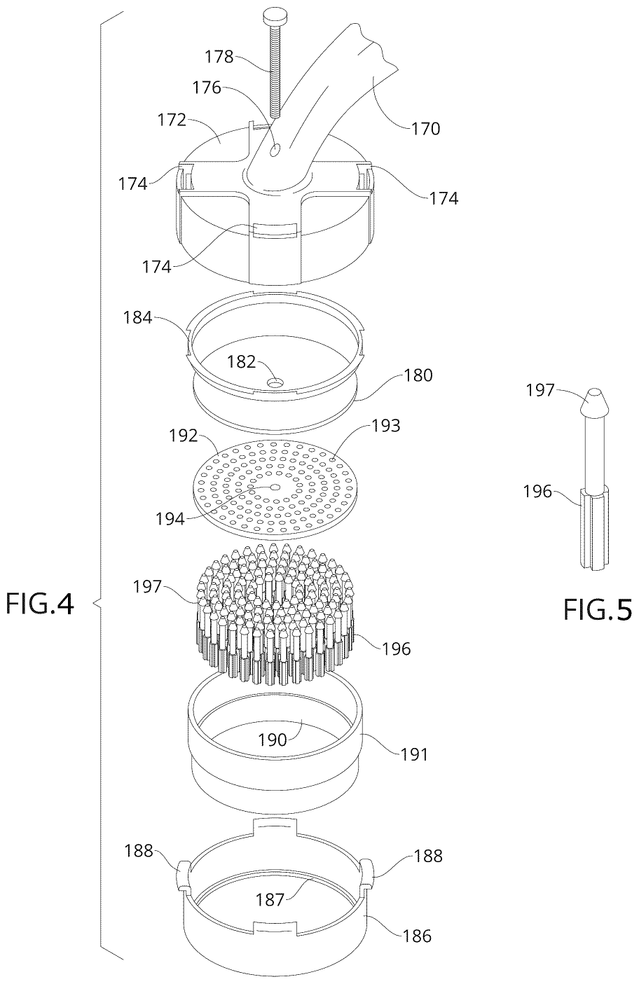

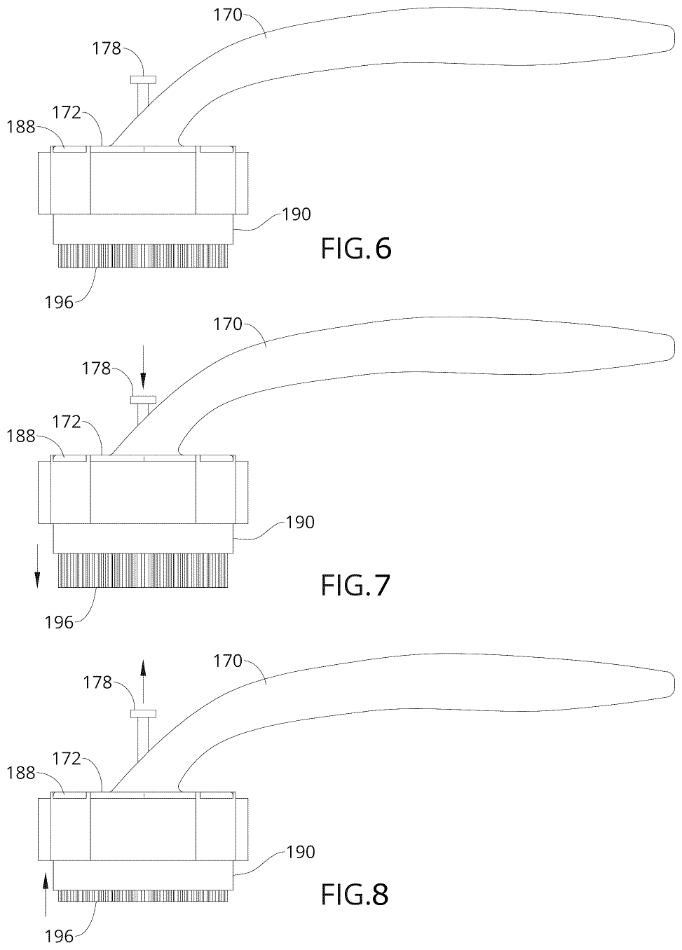

A first embodiment is shown in FIGS. 1-8. As illustrated in FIGS. 1 and 2, the pin cleaning tool comprises a cleaning tool handle 170 having a cleaning tool head 172 at one end with clip receivers 174 formed therein (see FIG. 4). The handle may have an elongated shaft configured to be comfortably held by a user's hand. The cleaning tool head may have a substantially cylindrical form. The cleaning tool head 172 houses a plurality of pins 196 having pin heads 197, as seen in FIG. 5. The pins 196 are generally held evenly spaced within pin holes 193 in a pin plate 192; see FIG. 4. A portion of the pins 196 may have a cruciform cross section, as shown in FIG. 3. A weighted disk or disk weight 180 rests above and adjacent to the pin plate 192 when in a use position. The weight 180 is spaced from the cleaning tool head 172 with a washer 184, having recessed regions co-located with the clip receivers. The weight 180 and the pin plate 192 may be fastened to the cleaning tool head 172 by way of a thumb screw 178; see also FIG. 6. The thumb screw 178 passes through a bore or thumb screw slot 176 formed through the handle 170, a weight through hole 182 formed within a disk weight 180, and through a pin plate thumb screw hole 194 formed within a pin plate 192. A clip-in sleeve 186, having a retaining ring 187 and clips 188 formed therein, is operative to secure a retaining ring 190 characterized by a circumferential shoulder such that an upper inner sleeve 191 is stepped from a lower portion thereof, enabling the retaining ring 190 to nest within the clip-in sleeve 186 (see FIGS. 2 and 4). The clips 188 are retained by the clip receivers 174. The pins 196 are generally urged downward by the weight 180, as seen in FIG. 7. The pins 196 may be individually urged upward against the weight 180 (see FIG. 8) when they are pressed against a surface, such as a grill grate 198, shown in FIG. 1.

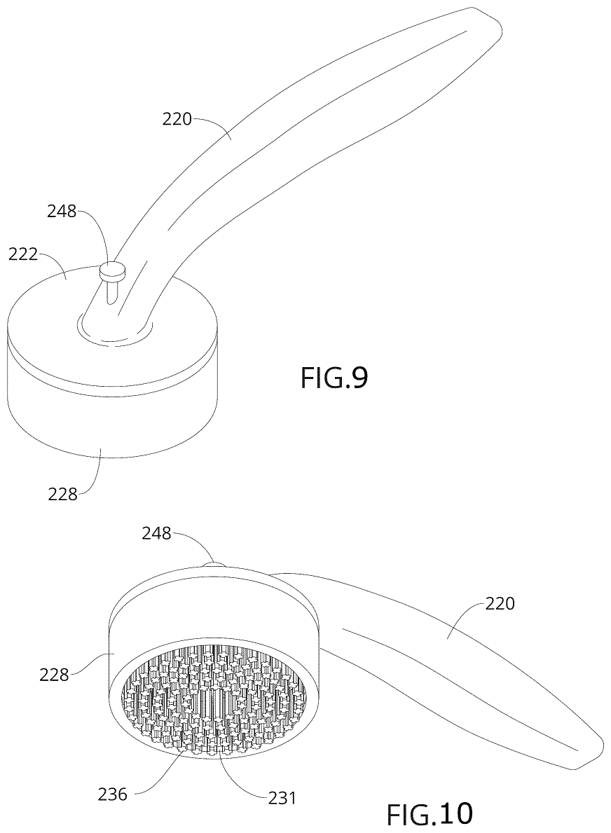

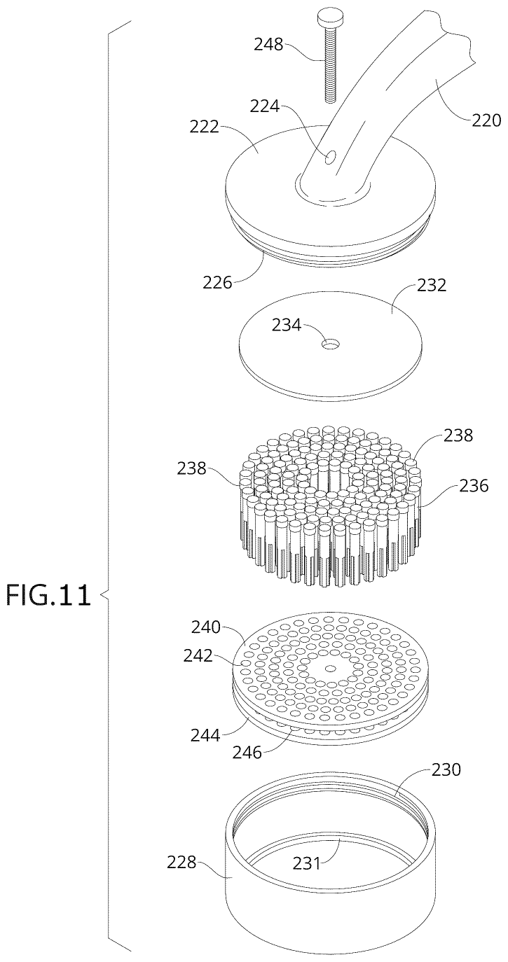

A cleaning tool according to a second embodiment may be seen in FIGS. 9-14. The cleaning tool comprises a cleaning tool handle 220 with a cleaning tool head 222 formed at one end thereof. A cylindrical sleeve 228 having a retaining ring 231 is threadedly coupled to the cleaning tool head 222 by way of head threads 226 and sleeve threads 230; see FIG. 11. The sleeve 228 houses a plurality of pins 236 evenly spaced within aligned pin plate holes 242, 246 formed in a pair of pin plates 240, 244. Twin pin plates 240, 244 rest on the retaining ring 231 of the sleeve 228. A disk weight 232 rests upon pin heads 238 formed on the pins 236. The weight 232 generally urges the pins 236 downward, while resistance from the grill grate 198 causes some of the pins 236 to retract into the sleeve 228. A thumb screw 248 engages a thumb screw slot or bore 224 formed in the handle 220, a weight slot 234 formed in the weight 232, and apertures formed in the pin plates 240, 244. In this embodiment, clips 188, clip receivers 174, a washer 184, and a retaining ring 190 may be absent.

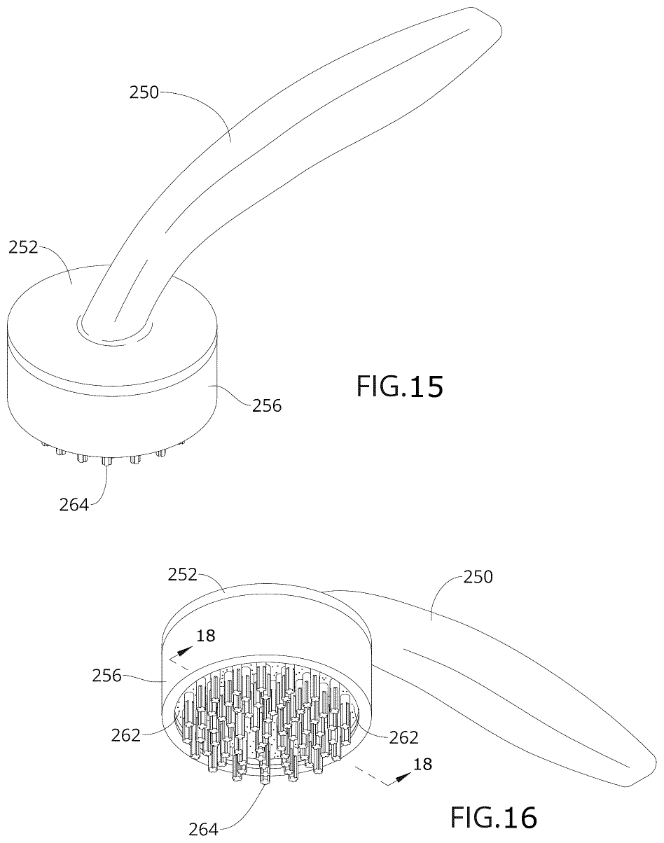

As shown in FIGS. 15-18, a third embodiment of the cleaning tool comprises a cleaning tool handle 250 with a cleaning tool head 252 formed at one end thereof. A sleeve or collar 256 with a retaining ring 257 (see FIG. 17) is threadedly coupled to the cleaning tool head 252 via head threads 254 and mated sleeve threads 258. A plurality of pins 264 are embedded in a flexible silicone disk 262 by pin heads 266. The silicone disk 262 is positioned between an upper spacer 260 and a lower spacer 268 with the sleeve 256, with the lower spacer resting on the retaining ring 257. In this embodiment, a weight 180, 232, a thumbscrew 178, 248 and associated bores and through holes 176, 182, 194, 224, 234 may be absent. The pins 264 extend beyond the sleeve 256, e.g., by about ¼ inch. When the cleaning tool is applied to a grill, the silicone disk 262 flexes, allowing the pins 264 to deflect, scraping the sides of the grill grate. The sleeve 256 may make contact with the top of the grill grate, scraping the top surface clean.

A washer cleaning tool 300 according to a fourth embodiment is illustrated in FIGS. 19-21. The cleaning tool 300 comprises a pair of mirror-image branch elements 304 diverging from one another to form a forked or wishbone-shaped frame with substantially parallel spaced-apart branches extending from a handle 302. The handle 302 has a hole 303 through one end. As shown in FIG. 21, a pin 306 extends between and through holes 305 in the branches 304 of the frame and through central holes 310 of a plurality of square washers or teeth 308 positioned therebetween. The washers 308 have edges 309 and a selected thickness. The ends of the pin 306 are threadedly coupled to screw caps 312, affixing them in place. As illustrated in FIG. 20, the grill grate 198 displaces a portion of the square washers 308, while the remaining washers 308 extend through gaps in the grate 198.

As shown in FIGS. 22-23, a fifth embodiment includes a substantially triangular body 324 with a handle 342 at a first end and a pair of legs or uprights extending from a second end. A washer retaining frame 316 is fastened to a second end by way of a set screw 341 within the body 324. The frame 316 may have a continuous, substantially rectangular shape. The washer retaining frame 316 is fastened to the legs using retainers 332. The handle 342 may have a cord 343 extending therethrough.

In a sixth embodiment illustrated in FIGS. 24-25, the body 342 may have a pair of uprights or legs 345 retaining a frame 344 with washer support 352. Each end of the washer support 352 may have a rectangular shape with a hole or aperture 353 through which a pin 346 is threadedly retained.

A seventh embodiment is shown in FIG. 26, having a clamp rather than a set screw. As illustrated in FIG. 26, the clamp may be released, the frame may be removed from the body, and the washers may be spread apart for more efficient cleaning.

FIG. 27-28 show an eighth embodiment of a cleaning tool with a body 362 to which a frame 364 is secured by way of bolts 361. The body may have a shaft expanding into a triangular portion and a rectangular prism base to which the frame 364 is fastened. The frame 364 may be formed, for example, by a metal sheet bent to form a rectangular surface with a tab extending therefrom and substantially triangular walls extending orthogonally from the rectangular surface. Stacked washers 308 are secured to the frame 364 between the substantially triangular walls by a pin with threaded ends held in place with nuts 366.

Ninth and tenth embodiments of the cleaning tool are illustrated in FIGS. 29-30 with alternative washer configurations. The concave square washers 318, 328 have four concave sides or edges 319, 329, and the washers 319 of FIG. 29 exhibit truncated corners. The washers 318, 328 each have a central through hole 320, 330 or bore that accommodates a pin.

FIGS. 31-32 show an eleventh embodiment of the cleaning tool with a square prism body 138 having a bar handle 136 extending parallel to one surface and a square plate 140 affixed to an opposite surface of the body 138. Metal sleeves 154 encompassing a wire lengthwise therethrough have cable crimps 153, hog rings 157, and grommets 158 securing each end. The grommets 158 slidably retain the metal sleeves 154 in parallel slots adjacent opposite edges of the plate 140.

As shown in FIGS. 33-34, a cleaning tool according to a twelfth embodiment includes a shaft or handle 382 having a semicircular blade 384 embedded within one end of the handle 382. A bar 386 around which a wire rope 388 is wound is fastened to the blade 384 along its flat edge with fastening hardware 392, such as screws. Looped ends of the wire rope 388 are secured to a central portion of the blade 384 with a washer 381 and fastening hardware, such as a bolt and washer.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. The term “substantially” shall be interpreted to mean completely and/or nearly completely. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A cleaning tool, comprising:
an elongated handle (170, 220, 250);
a housing (172, 222, 252) formed at an end of the elongated handle (170, 220, 250), wherein the housing (172, 222, 252) comprises a sleeve (186, 191, 228, 256) and/or a ring (190, 231, 257);
a pin plate (192, 240, 244, 262) housed within the housing (172, 222, 252); and
a plurality of scraping pins (196, 236, 264) configured as a parallel array mounted within the pin plate (192, 240, 244, 262), and extending from the housing (172, 222, 252).

2. The cleaning tool of claim 1, wherein the scraping pins (196, 236) retract into the housing (172, 222) when pressed against a surface (198).

3. The cleaning tool of claim 1, wherein the housing (172, 222, 252) further comprises a cleaning head (172) with clip receivers (174) formed therein and a retaining ring (187) having clips (188) extending therefrom, and wherein the clips (188) are configured to align with the clip receivers (174) and the clip receivers (174) are configured to securely accommodate the clips (188).

4. The cleaning tool of claim 1, further comprising a disk weight (180, 232) positioned on the pin plate (192, 240, 242) within the housing (172, 222).

5. The cleaning tool of claim 1, further comprising an adjustable thumbscrew (178, 248) threadedly mounted through a thumb screw slot (176, 224) formed in the elongated handle (170, 220) proximal to the housing (172, 222), holes (182, 234), and a pin plate thumb screw hole (194) formed through the pin plate (192, 240, 242).

6. A cleaning tool, comprising:
a handle (302, 342, 362);
a cleaning tool head (304, 324, 364) formed at an end of the handle (302, 342, 362);
a shaft (306, 316, 346) mounted on the cleaning tool head (304, 324, 364) and secured thereto with fastening hardware (312, 341, 366); and
a plurality of washers (308, 318) mounted on the shaft (306, 316, 346);
wherein a first set of the plurality of washers (308, 318) are displaced when pressed against a surface as compared to a second set of the plurality of washers (308, 318) that remain in a resting position.

7. The cleaning tool of claim 6, wherein the plurality of washers (308) has a substantially square perimeter (309) and a central bore (310) therethrough.

8. The cleaning tool of claim 6, wherein the plurality of washers (318, 328) with concave edges (319, 329) and a central bore (320, 330) formed therethrough.

9. The cleaning tool of claim 6, wherein the cleaning tool head (304, 324) has a wishbone shape.

10. The cleaning tool of claim 6, wherein the shaft (316) is configured as a closed, substantially rectangular frame.

11. A grill cleaner comprising:
a planar base (138, 384);
a handle (136, 382) mounted to the planar base;
a metal support (140, 386) mounted to the planar base (138, 384); and
an abrasive component (154, 388) fastened to the metal support (140, 386);
wherein the handle (136, 382), the metal support (140, 386), and the abrasive component (154, 388) are fastened to the planar base (138, 384).

12. The grill cleaner of claim 11, wherein the planar base (138) is substantially square and the handle (136) is fastened parallel to the planar base (138).

13. The grill cleaner of claim 11, wherein the abrasive component comprises mesh sleeves (154), each crimped to a wire in a longitudinally compressed condition and slidably mounted to the metal support (140).

14. The grill cleaner of claim 11, wherein the planar base is a semicircular blade (384), the handle (382) is fastened to an arcuate edge of the semicircular blade (384), and the metal support is an elongated bar (386) mounted adjacent to an edge of the semicircular blade (384) opposite the handle (382).

15. The grill cleaner of claim 14, wherein the abrasive component is a cord (388) wound about the elongated bar (386) and further fastened to the semicircular blade (384).
